(19) United States
(12) Patent Application Publication
(10) Pub. No.: US 2026/0244559 A1
(43) Pub. Date: Aug. 20, 2026

(54) PERFORMANCE MONITORING CIRCUITRY, METHOD AND COMPUTER PROGRAM

(71) Applicant: Arm Limited, Cambridge (GB)

(72) Inventor: Michael John Williams, Cambridge (GB)

(73) Assignee: Arm Limited, Cambridge (GB)

(21) Appl. No.: 19/157,547

(22) PCT Filed: Jan. 5, 2024
(86) PCT No.: PCT/GB2024/050023

§ 371 Date: Aug. 18, 2025

(30) Foreign Application Priority Data
Feb. 24, 2023 (GB) 2302657.8

(51) Int. Cl. G06F 11/3668

(52) U.S. Cl. CPC G06F 11/3688

(57) ABSTRACT

Performance monitoring circuitry (40) has event counters (42) each to maintain a respective event count value based on monitoring of events during processing of the software by the processing circuitry. Control circuitry (44) configures the event counters based on counter configuration information. For at least a subset of the event counters, a given event counter (42) in the subset supports a chained-counter operation comprising incrementing a given event count value by an increment value determined based on a logical combination of a first event status indication indicative of status of a first event type assigned by the counter configuration information to be monitored by the given event counter and a second event status indication indicative of status of a second event type assigned by the counter configuration information to be monitored by a further event counter.

The present technique relates to the field of data processing. More particularly, it relates to performance monitoring.

A data processing system may have performance monitoring circuitry for monitoring performance of software executing on processing circuitry. The performance monitoring circuitry includes event counters for counting occurrences of various events, such as the execution of an instruction, a miss in a cache or translation lookaside buffer, a buffer becoming full, instruction execution stalling, etc. The event count values maintained by the counters can be read by debug software and used for analysis of software performance to help identify possible reasons for any performance issues when the software is executing on the data processing system.

At least some examples provide performance monitoring circuitry for monitoring performance of software executing on processing circuitry; comprising: a plurality of event counters each to maintain a respective event count value based on monitoring of events during processing of the software by the processing circuitry; and control circuitry to configure the event counters based on counter configuration information, the counter configuration information comprising event type assignment information indicative of which types of event are assigned to be monitored by the event counters; wherein: for at least a subset of the event counters, a given event counter in the subset is configured to support a chained-counter operation for at least one setting of the counter configuration information, and the given event counter is configured to maintain a given event count value; the chained-counter operation comprising incrementing the given event count value by an increment value determined based on a logical combination of a first event status indication indicative of status of a first event type assigned by the counter configuration information to be monitored by the given event counter and a second event status indication indicative of status of a second event type assigned by the counter configuration information to be monitored by a further event counter.

At least some examples provide an apparatus comprising the performance monitoring circuitry mentioned above and the processing circuitry.

At least some examples provide a computer-readable medium to store computer-readable code for fabrication of the performance monitoring circuitry or the apparatus mentioned above. The computer-readable medium may be a non-transitory storage medium.

At least some examples provide a method for monitoring performance of software executing on processing circuitry; the method comprising: configuring a plurality of event counters based on counter configuration information, the counter configuration information comprising event type assignment information indicative of which types of event are assigned to be monitored by the event counters; using the plurality of event counters, maintaining respective event count values based on monitoring of events during processing of the software by the processing circuitry; and for a given event counter within at least a subset of the event counters, performing a chained-counter operation for at least one setting of the counter configuration information, the given event counter maintaining a given event count value; the chained-counter operation comprising incrementing the given event count value by an increment value determined based on a logical combination of a first event status indication indicative of status of a first event type assigned by the counter configuration information to be monitored by the given event counter and a second event status indication indicative of status of a second event type assigned by the counter configuration information to be monitored by a further event counter.

At least some examples provide a computer program comprising instructions which, when executed by a host data processing apparatus, control the host data processing apparatus to provide an instruction execution environment for executing target program code, the computer program comprising: event counting program logic to maintain a plurality of event count values based on monitoring of events during simulated processing of the target program code by target processing circuitry; and control program logic to configure the event counting program logic based on counter configuration information, the counter configuration information comprising event type assignment information indicative of which types of event are assigned to be monitored using the plurality of event count values by the event counting program logic; wherein: for at least a subset of the event count values, for at least one setting of the counter configuration information the event counting program logic is configured to support a chained-counter operation for maintaining a given event count value in the subset; the chained-counter operation comprising incrementing the given event count value by an increment value determined based on a logical combination of a first event status indication indicative of status of a first event type assigned by the counter configuration information to be monitored using the given event count value and a second event status indication indicative of status of a second event type assigned by the counter configuration information to be monitored by a further event counter.

At least some examples provide a computer-readable storage medium storing the computer program mentioned above. The storage medium may be a non-transitory storage medium.

Further aspects, features and advantages of the present technique will be apparent from the following description of examples, which is to be read in conjunction with the accompanying drawings, in which:

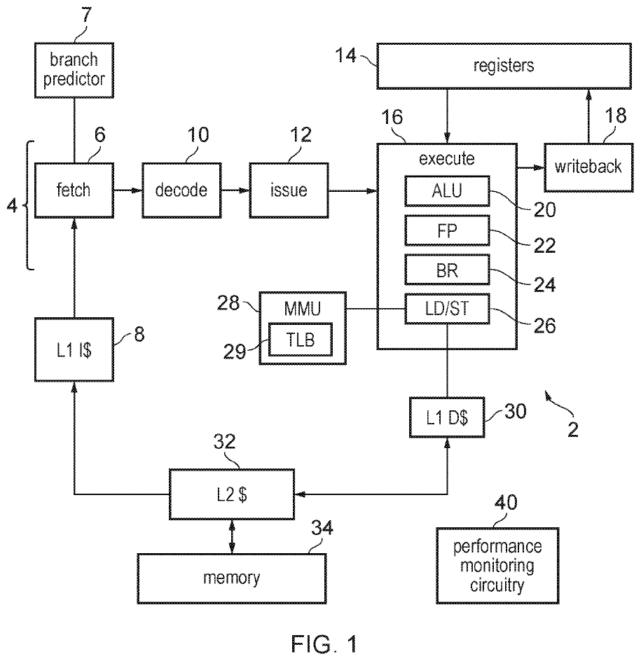

FIG. 1 illustrates an example of a data processing system having performance monitoring circuitry;

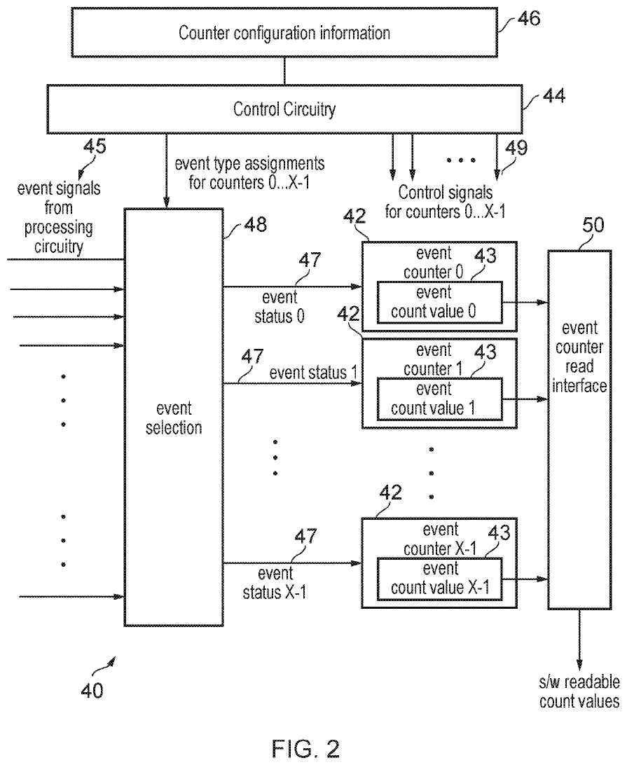

FIG. 2 illustrates an example of performance monitoring circuitry;

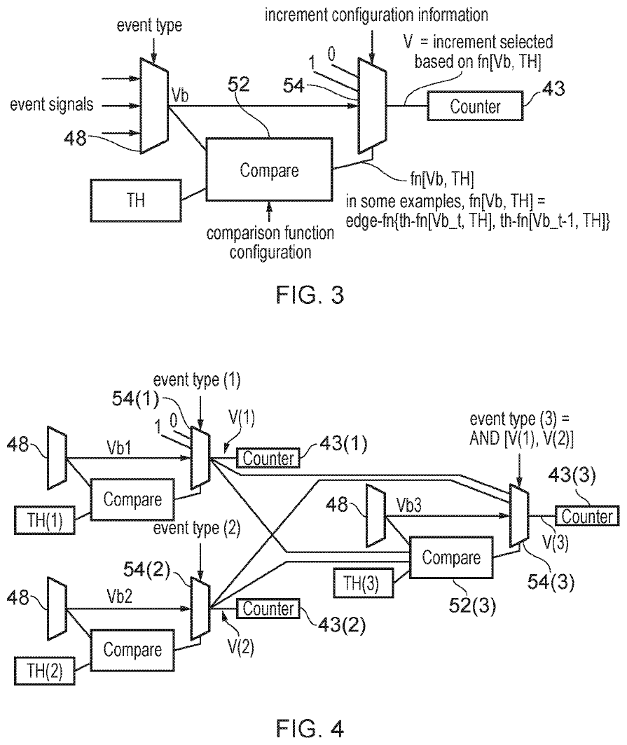

FIG. 3 illustrates an example of an event counter being incremented based on an increment value selected as a function of an event status indication;

FIG. 4 illustrates, for comparison, an approach where a third event counter is configured to increment its count value based on the logical combination of outputs of two other counters which depend on event status indications indicating status of events assigned by counter configuration information to those two other counters;

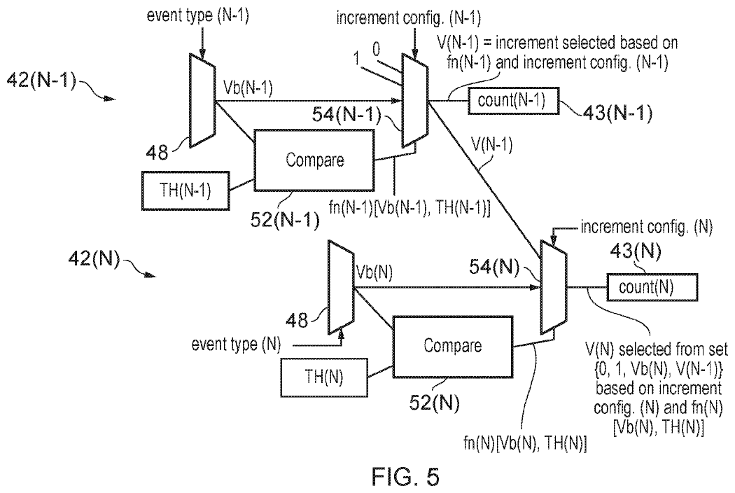

FIGS. 5, 6 and 7 illustrate alternative techniques for controlling a given counter to increment a given count value by an increment value selected based on the logical combination of a first event status indication indicating status of a first event type assigned to be monitored by the given counter itself and a second event status indication indicating status of a second event type assigned to be monitored by a further event counter;

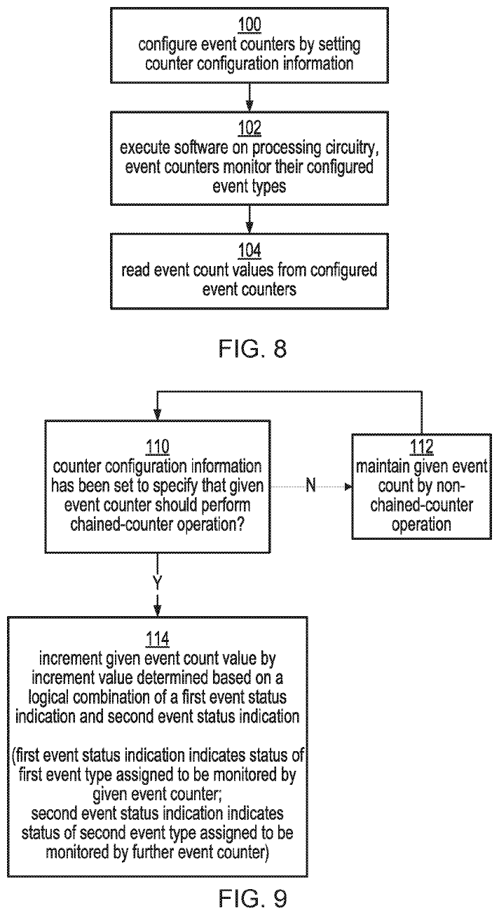

FIG. 8 is a flow diagram illustrating performance monitoring using event counters;

FIG. 9 is a flow diagram illustrating performing a chained-counter operation;

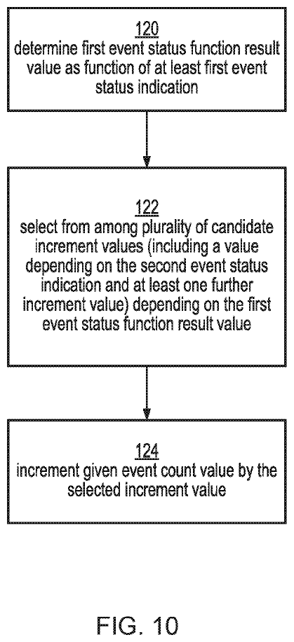

FIG. 10 is a flow diagram illustrating a particular example in which the second event status indication is one of the candidate increment values available for selection depending on a first event status function result value; and

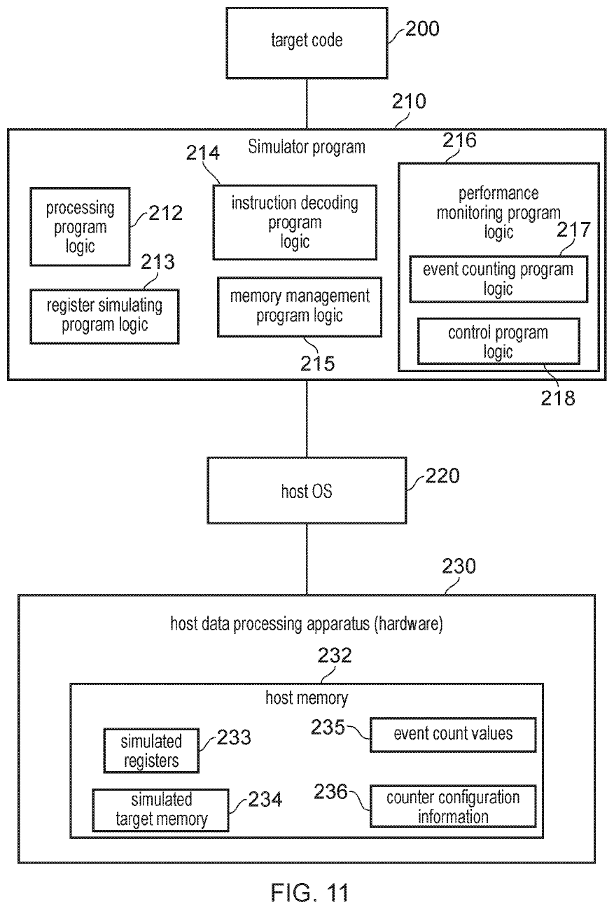

FIG. 11 illustrates a simulation example.

Performance monitoring circuitry is provided for monitoring performance of software executing on processing circuitry. The performance monitoring circuitry comprises two or more event counters each to maintain a respective event count value based on monitoring of events during processing of the software by the processing circuitry, and control circuitry to configure the event counters based on counter configuration information. The counter configuration information comprises event type assignment information indicative of which types of event are assigned to be monitored by the event counters. Such performance monitoring circuitry can be useful to investigate possible causes of poor performance when software is executing on processing circuitry, as the event count values can expose information about internal events occurring within the processing circuitry while the software is executing (such as cache misses, branch mispredictions, instruction stalls, buffers becoming full, etc.).

In the examples below, for at least a subset of the event counters, a given event counter in the subset is configured to support a chained-counter operation for at least one setting of the counter configuration information. The event count value that is maintained by the given event counter is referred to as the “given event count value” below. The chained-counter operation comprises incrementing the given event count value by an increment value determined based on a logical combination of a first event status indication indicative of status of a first event type assigned by the counter configuration information to be monitored by the given event counter and a second event status indication indicative of status of a second event type assigned by the counter configuration information to be monitored by a further event counter.

Such a chained-counter operation is useful to give information about the combined occurrence of multiple distinct event types which would normally be counted by different counters. For example, the logical combination may implement functions such as AND, so that the given event count value can be an indication of the number of times an event of the first event type and an event of the second event type occurred simultaneously, or OR, so that the given event count value can be an indication of the total number of cycles in which one or both of the two types of event occurred. Such combined functions can sometimes give more useful diagnostic information than separate counts of each event type individually.

The chained-counter operation comprises incrementing the given event count value (maintained by the given event counter) based on the logical combination of the first event status indication corresponding to the first event type assigned to be monitored by the given event counter and the second event status indication corresponding to the second event type assigned to be monitored by a further event counter. This can be a particularly efficient approach for generating an event count value as a combined status of two distinct events.

Firstly, this approach can help to conserve hardware costs of implementing the event counters and associated control hardware. To allow configurable selection of the event types counted by the event counters (selected based on counter configuration information which may be programmable by a user), each event counter may be associated with event selection hardware logic (e.g. a multiplexer) to select which of a number of distinct event status signals is provided to the event counter logic to control the increment of the corresponding event count value. For an approach not supporting the chained-counter operation, one might implement such event selection hardware logic so that each event counter's event selection hardware logic is able to select a single event signal at a time. In the chained-counter operation, by using the further event counter's assigned second event type as an additional input to the given event counter (rather than allowing a second type of event to be defined arbitrarily for the given event counter independently of any events assigned to other counters), this means that the chained-operation on the given event counter can make use of the event selection hardware logic provided for the further event counter, rather than needing to increase the complexity of the event selection hardware logic associated with the given event counter to support selection of more than one event type per counter. Hence, this can conserve hardware cost of implementing the chained-counter implementation.

Also, by incrementing the given event count value based on the logical combination of the first event status indication corresponding to the first event type assigned to be monitored by the given event counter itself and the second event status indication corresponding to the second event type assigned to be monitored by a further event counter, this means it is not necessary to utilize a third counter to obtain a count value based on the combined status of the first/second event types (in contrast to an alternative approach where a third counter increments its counter based on a logical combination of statuses of first and second event types assigned by the counter configuration information to two other counters). As the number of event counters supported in hardware may be limited, freeing up a counter for other purposes can be useful to allow an additional item of performance monitoring information (e.g. for an event unrelated to the first and second event types) to be gathered in scenarios where the user does not consider it necessary to maintain individual counts of the number of occurrences of both the first and second events as well as the combined count based on the logical combination of the status signals corresponding to those events.

The first event status indication and second event status indication can be any signal indicating the status of something happening at a given part of the processing circuitry. For some event types, the event status indication could be a two-state indication indicating whether or not a certain event has occurred in a given cycle. For example, an event status indication could indicate whether or not a cache miss has occurred in a current cycle, or whether a load instruction has been executed in a current cycle. Alternatively, in some implementations event signals may be communicated to the performance monitoring circuitry at intervals less frequent than every cycle (or some types of events may occur more than once in the same cycle), and so the event status indication may indicate the number of occurrences of the corresponding event type since the previous update of the event status indication. For example, an event signal could indicate the number of cache misses that have occurred since the previous update. Also, in some cases the event status indication may indicate a quantitative parameter representing the current state of a component of the processing circuitry, rather than a mere yes/no indication of whether or not an event has occurred. For example, for one event type, the event status indication may indicate a current occupancy of a buffer (e.g. number of pending loads pending in a load buffer). Therefore, it will be appreciated that the event status indication can be represented in many different ways depending on the type of event being tracked.

The counter configuration information may comprise information for specifying which logical combination is to be used for combining the first event status indication and the second event status indication. For example, the chained-count operation may support a number of different logical combinations and the counter configuration information may select which logical combination to use. For example, the information identifying the logical combination could specify a Boolean function (such as AND or OR) to be applied for combining the first event status indication and the second event status indication. Alternatively, the information identifying the logical combination could specify how the increment value for incrementing the given event count value should be selected, based on the first/second event status indications (as explained further below, in some implementations, an equivalent result to a Boolean combination such as AND or OR can be generated by processing the first/second event status indications individually and then using the results to adjust the selection of the increment value, so it is not essential to include circuit logic for directly combining the first/second event status indications in a Boolean function).

In some examples, the chained-counter operation comprises determining a first event function result value for the given event counter as a function of at least the first event status indication, and selecting one of a plurality of candidate increment values as the increment value for incrementing the given event count value based on selection control information depending on at least the first event function result value. For example, the function could comprise a threshold function and/or edge function as mentioned further below. At least one of the first event function result value, the selection control information and one or more of the candidate increment values depends on the second event status indication.

Hence, the second event status indication can influence the chained-counter operation in different ways, depending on the implementation chosen.

In some examples, the selection control information and/or one or more of the candidate increment values may depend on the value dependent on the second event status indication. For example, the value dependent on the second event status indication can be an input to the increment selection multiplexer which selects from among the candidate increment values based on the selection control information. Introducing the dependency on the second event status indication at the increment selection multiplexer rather than the circuitry for evaluating the first event function result value can be helpful to reduce hardware cost, by avoiding any need to make the function computation circuitry for computing the function of the first event status indication any more complex than would be provided for supporting a non-chained-counter operation where the given event counter is to be incremented based on a function of the first event status indication independent of the second event status indication. It may be more efficient to adapt the circuitry for selecting the increment to support consideration of the second event status indication. Also, this can make it simpler to meet circuit timing requirements, as introducing the value dependent on the second event status indication at the increment selection multiplexer means the computation of the first event function result value does not need to be delayed while waiting for the further event counter to provide the value dependent on the second event status indication.

In some examples, the plurality of candidate increment values include the value dependent on the second event status indication and at least one further increment value. The inventor has recognised that a result equivalent to a logical combination of first/second event status (such as Boolean AND or OR) can be simulated by providing a value dependent on the second event status indication as an option for selection as the increment value at the given event counter, and selecting between the value dependent on the second event status indication and the at least one further increment value based on the first event function result value (which is derived from the first event status indication). This avoids the need to include circuitry for actually combining the first/second event function result values in a Boolean combination. Hence, this approach can be particularly efficient in supporting the chained-counter operation, with reduced added complexity in the hardware circuit logic compared to an approach where each counter can only increment its count value based on a function of a single event type's event status indication.

The at least one further increment value (provided as an alternative to selecting the value dependent on the second event status indication as the increment value) may comprise at least one of: 0; 1; and the first event status indication. In implementations supporting more than one of these options for the further increment value, the counter configuration information may specify which option to use for the further increment value for a given instance of performing the chained-counter operation.

In some examples, the selection control information depends on the value dependent on the second event status indication (as well as depending on the first event function result value). In this case, a value dependent on the second event status indication is used as a control input to the increment selection multiplexer that controls which increment value is selected. A value dependent on the second event status indication could also be provided as one of the candidate increment values available for selection.

In other examples, first event function result value may depend on the value dependent on the second event status indication. In this case, the first event function result value may be computed as a function of both the first event status indication and the value dependent on the second event status indication, and the first event function result value can then be used to select the increment value to be used for incrementing the given event count value (in this case, the increment selection does not need to have an additional dependency on the second event status indication, other than that the first event function result value depends on the second event status indication). This approach can give increased flexibility on the range of logical combinations that can be used to combine the first/second event statuses. For example, this approach could support combination functions such as determining the minimum or maximum of the numbers indicated by the first/second event statuses.

The selection of the increment value may also depend on other information (not dependent on the first/second event status indications). For example, the selection of the increment value may also depend on the counter configuration information for the given event counter. In one example, the first event function result value may be used to select between two alternative candidate increment values, and the counter configuration may specify information for selecting which of a wider set of three or more candidate increment values supported in hardware should be the two alternative candidate increment values from which the selection is made based on the first event function result value. In some implementations (e.g. where the value dependent on the second event status indication is used as one of the two alternative candidate increment values), the information defining the two alternative candidate increment values may be the information which defines whether the chained-counter operation is to be performed at all (e.g. in a setting of the counter configuration information where the second event status indication is not one of the two alternative candidate increment values, the increment value may be independent of the second event status indication and so the given event counter may instead perform a non-chained-counter operation).

The value dependent on the second event status indication (used as a candidate increment value for the given event counter, a control input to the selection circuitry which selects the increment value for the given event counter, or as an input to the function used to determine the first event function result value) can be implemented in different ways. For example, depending on implementation choice, the value dependent on the second event status indication could be any of:
the second event status indication (e.g. for event types where the second event status indication is a two-state indication of whether an event has happened, it may not be necessary to further qualify it before using it for the chained-counter operation);
a second event function result value determined for the further event counter as a function of at least the second event status indication (e.g. for a quantitative status indication, it may be helpful to generate a two-state indication indicative of whether the number indicated by the second event status indication meets a particular criterion (e.g. whether it is greater than a threshold)); and
a second increment value selected for incrementing the further event counter based on at least the second event function result value (in some cases, the increment value selected by the further event counter may be helpful in allowing the increment value for the given event counter to represent the logical combination of the first/second event status indications).

The function used to compute the first event function result value can vary.

In some examples, for at least one setting of the counter configuration information, the first event function result value comprises a threshold function result value indicative of whether the first event status indication and a threshold value satisfy a threshold condition. Such threshold functions are useful as there may be some kinds of events where the event is only significant enough to be counted if the event status indication exceeds a threshold. For example, some performance effects may be caused by certain buffers or queues becoming full or near full, so that it may be useful to count the number of times a certain buffer or queue occupancy exceeds a threshold. Similarly, underutilization of some components could be probed based on whether occupancy of a queue is less than a threshold.

The threshold value for the threshold function may be specified by the counter configuration information, so that the user can program the counter configuration information to set the threshold value to the desired level. Hence, the threshold value may be a pre-configured value defined solely by the counter configuration information set by the user, independent of the status of any of the events being monitored by the performance monitoring circuitry.

It is also possible for the particular threshold condition applied to be variably controlled based on the counter configuration information. For example, the threshold condition could be one of: whether the first event status indication equals the threshold value, whether the first event status indication is not equal to the threshold value, whether the first event status indication is greater than or equal to the threshold value, and whether the first event status indication is less than the threshold value (other options are also possible). The counter configuration information may specify which specific type of threshold condition should be applied for a particular event counter.

In some examples, for at least one setting of the counter configuration information, the first event function result value comprises an edge function result value indicative of whether, between a previous cycle and a current cycle, there has been a change in whether the first event status indication satisfies a predetermined condition. In some cases, the predetermined condition may be the threshold condition used for evaluating the threshold function based on the first event status indication and the threshold value as discussed above, but it is also possible for the edge function to depend on evaluation of other functions of the first event status indication which are not based on a threshold value. Edge functions can be useful for performance monitoring when it is desirable to obtain a count of the number of distinct occasions when a condition became satisfied (rather than the total number of cycles when that condition is satisfied). For example, the edge function could be used to count the number of distinct occasions when a buffer became full (as opposed to counting the duration (number of cycles) for which the buffer remains full, which can be done with a non-edge function).

Hence, the chained-counter operation can select the increment for the given event counter based on a logical combination of the result of applying a threshold and/or edge function to the first event status indication and a value dependent on the second event status indication indicating status of an event assigned to a further event counter. That value dependent on the second event status indication could itself depend on a threshold and/or edge function calculated by the further event counter based on the second event status indication. This provides a flexible infrastructure for computing a range of useful information about the co-occurrence of two events.

There may be different approaches for selecting which other counter is the further event counter whose second event status indication is used to derive information for the chained-counter information being performed by the given event counter.

In some examples, for the chained-counter operation performed by the given event counter, selection of which other event counter is the further event counter is fixed, independent of the counter configuration information. In this case, each event counter in the subset capable of performing the chained-counter operation may be limited to using only one other counter as the further event counter. It may not be possible to vary which other counter is the further event counter corresponding to a given event counter. For example, if there are a given set of counters assigned counter numbers in some range (e.g. 0 to X−1), then one approach could be to constrain that for any given event counter with counter number N, if the chained-counter operation is to be performed by the given event counter, the further event counter to be used for the chained-counter operation would be the counter with counter number N−1, say. Other examples may have a different approach to defining which counter is the further event counter corresponding to any given event counter. By limiting the combinations of event counters so that each counter can only take the value dependent on the second event status indication from one other counter, this greatly reduces the hardware complexity of implementing the chained-counter operations for a number of counters, as the number of inter-counter wiring connections needed is reduced compared to an implementation with more flexible choice of which counter is the further event counter. In practice, the limitation of which combinations of event counters should not limit the options available to the user because the user can choose which events are allocated to each counter so that the event types to be combined in the logical combination are assigned to a pair of counters which do support one event counter of the pair being the further event counter for the other event counter of the pair when the other counter is the given event counter performing the chained-counter operation.

On the other hand, other examples could support the counter configuration information variably specifying which other event counter is the further event counter for the chained-counter operation performed by the given event counter. This can give added flexibility to vary the combinations of event types in different ways, but may increase hardware complexity.

In some examples, all of the event counters may be in the subset of event counters which support the chained-counter operation.

In other examples, the chained-counter operation may be supported for only a proper subset of the event counters, and there may be at least one event counter which does not support the chained-counter operation. For example, in an approach where the given event counter with counter number N is restricted to using, as the further event counter, a counter with event counter N−1, it may be that event counter 0 does not support the chained-counter operation as there would be no other counter with event counter N−1 (alternatively, counter 0 could use the counter with the maximum counter number as the further event counter). In other examples, the subset of event counters supporting the chained-counter operation may be further restricted so there may be two or more event counters which are outside the subset and so do not support the chained-counter operation. It may be considered that it is unlikely that all the counters will be needed to perform the chained-counter operation at the same time, as in practice it is likely some counts of single event types may also be desired, so it can be useful to limit the hardware cost by reducing the number of event counters in the subset that support the chained-counter operation.

An apparatus may comprise the performance monitoring circuitry mentioned above, as well as the processing circuitry whose operation is monitored by the performance monitoring circuitry.

A computer-readable medium may store computer-readable code for fabrication of the performance monitoring circuitry or the apparatus mentioned above. As described further below, this can provide an electronic representation of the circuit design, which can be disseminated to another party to enable that party (or a further party downstream in the manufacturing chain) to manufacture the performance monitoring circuitry or the apparatus.

The techniques discussed above may be implemented using hardware circuitry provided for implementing the event counters and control circuitry discussed above.

However, the same technique can also be implemented within a computer program which executes on a host data processing apparatus to provide an instruction execution environment for execution of target program code. Such a computer program may control the host data processing apparatus to simulate the architectural environment which would be provided on a hardware apparatus which actually supports target code according to a certain instruction set architecture, even if the host data processing apparatus itself does not support that architecture. The computer program may have event counting program logic and control program logic which emulates functions of the event counters and control circuitry discussed above, including support for the chained-counter operation. Such a simulation can allow software development of target program code (e.g. debugging software intended for an apparatus having the performance monitoring circuitry discussed above) to start before the hardware having the performance monitoring circuitry is actually ready. By executing the target program code on the simulated execution environment, this can enable testing of the target code in parallel with ongoing development of the hardware devices supporting the new features of the performance monitoring circuitry. The simulation program may be stored on a storage medium, which may be a non-transitory storage medium.

FIG. 1 schematically illustrates an example of a data processing apparatus 2. The data processing apparatus has a processing pipeline 4 (an example of processing circuitry, which could for example form part of a CPU (Central Processing Unit)). The processing circuitry 4 is for executing instructions defined in an instruction set architecture (ISA) to carry out data processing operations represented by the instructions. The processing pipeline 4 includes a number of pipeline stages. In this example, the pipeline stages include a fetch stage 6 for fetching instructions from an instruction cache 8 (e.g. selection of which instructions are fetched may be controlled based on predictions of branch outcomes made by a branch predictor 7); a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions defined in the ISA that are decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34.

A memory management unit (MMU) 28 is provided for controlling memory access permission checks and performing address translations between virtual addresses specified by the load/store unit 26 based on operands of data access instructions and physical addresses identifying storage locations of data in the memory system. The MMU has a translation lookaside buffer (TLB) 29 for caching address translation data from page tables stored in the memory system, where the page table entries of the page tables define the address translation mappings and may also specify access permissions which govern whether a given process executing on the pipeline is allowed to read, write or execute instructions from a given memory region. While the MMU 28 is shown as associated with the load/store unit 26, the MMU 28 may also be looked up on instruction fetches triggered by the fetch stage 6 (or a separate instruction-side MMU may be implemented to handle instruction fetches, separate from the data-side MMU used by the load/store unit 26 for data accesses—in this case both MMUs can cache in their TLBs 29 information from a shared set of page tables).

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline implementation, and the processor may include many other elements not illustrated for conciseness.

The apparatus 2 also has performance monitoring circuitry 40 for monitoring performance of software executing on the processing circuitry 4. The performance monitoring circuitry 40 is shown in more detail in FIG. 2. As shown in FIG. 2, the performance monitoring circuitry 40 includes a number of event counters 42 which each maintain a corresponding event count value 43. The performance monitoring circuitry also includes control circuitry 44, which configures how the event counters behave, based on counter configuration information 46 set by a user. For example, the counter configuration information 46 could be state information stored in registers 14 of the processor (e.g. system registers), could be stored in memory-mapped registers implemented as distinct hardware separate from the memory system 30, 32, or stored within the memory system 30, 32, 34 itself (in the case of memory-mapped registers or a data structure in memory itself being used to provide the counter configuration information, the control circuitry 44 may access those registers/structure based on a base address that is programmable by the user). Hence, in general a programming interface is provided to allow a user (e.g. a software developer performing debugging) to program the counter configuration information 46 so that the event counters 42 can be configured to gather various types of performance monitoring information of interest when debugging a particular program running on the processing circuitry 4. For example, debugging software may be executed to set the counter configuration information. The target program being debugged can then be executed. During execution of the target program, the performance monitoring circuitry 40 functions according to the previously set counter configuration information.

The performance monitoring circuitry 40 includes event selection circuitry 48 which receives from the processing circuitry 4 and other parts of the data processing system 2 a number of event signals 45 which indicate status of a corresponding type of event. Although shown as a single logic block in FIG. 2, the event selection circuitry may comprise a separate event selector for each event counter, which independently selects the event signal 45 to be monitored by the corresponding event counter.

For example, event signals could be generated to indicate a wide variety of types of information about various components of the data processing apparatus 2.

Some event signals may indicate the occurrence of a specific action (or a count of how many times that action has occurred). For example, such an action may include any of:
elapse of a clock cycle;
execution of an instruction (either any instruction in general, or an instruction of a specific type);
a memory access request being made (either any memory access in general, or memory accesses of specific types, e.g. loads or stores);
a cache access, cache linefill or cache miss occurring (in some cases, this could be specific to a particular level or type of cache);
a TLB access, TLB linefill or TLB miss occurring (again, this could be events tracked for any TLB in general, or could be specific to particular TLB instances (e.g. data-side TLB or instruction-side TLB) or particular TLB levels (e.g. level 1 or level 2);
a branch misprediction occurring;
a queue or buffer becoming full (variants of which can be provided for specific buffers such as an instruction issue queue, load buffer, store buffer, etc.); or
a stall of the pipeline occurring due to a particular cause (e.g. a cache miss, a TLB miss, or a load or store buffer becoming full).
   Other event signals may specify quantitative information providing a quantitative status value indicating a property of an event that has occurred, such as:
a number of page table walk operations (requests to fill the TLB with a page table entry loaded from memory) in progress in a given cycle;
a number of cache linefill requests (requests to bring data into a cache following a cache miss) pending in a given cycle; or
an indication of current occupancy of a particular instance of a queue or buffer provided in hardware.

It will be appreciated that the lists of event types above are not exhaustive and that a wide variety of different event types could be monitored.

Also, in some cases, the event type assigned to a given event counter 42 may be the overflow of another of the event counters 42, which allows the numeric range over which a particular event is counted to be expanded beyond the numeric range supported in a single counter. Note that in this case although the two counters are “chained” together in the sense that they effectively represent a larger counter counting a single event type, the resulting count value tracked by the second event type in the chain (the one being incremented based on the overflow of the first event counter) is not a function of a logical combination of two distinct event types assigned by the counter configuration information as in the examples discussed below, as the second counter is incremented based on occurrences of the first counter's overflow only, not the logical combination of the first counter's overflow and the status of the event signal which causes that first counter to be incremented.

The counter configuration information 46 includes event type assignment information which specifies the event type to be monitored by each event counter 42. For example, each event counter 42 may have a corresponding event type field within the counter configuration information which has an encoding selecting which of the event signals 45 to use for a particular event counter 42. For each event counter, the event selection circuitry 48 selects, based on the event type assignment information for that counter, one of the event signals 45 which is passed to the corresponding event counter 42 as an event status indication 47 representing the status of the event assigned to that event counter 42 by the counter configuration information 46.

For each event counter 42, a set of hardware circuit logic is provided including storage circuitry for storing the corresponding event count value 43 and counter control logic circuitry (implemented in hardware) for updating the event count value as a function of the event status indication 47 provided to that counter 42 by the event selection circuitry 48. For example, an increment value may be selected as a function of the event status indication 47 and a new value of the event counter value 43 may be calculated by adding the increment value to the previous value of that event counter value 43. Control signals 49 may be provided to each event counter 42 by the control circuitry 44, based on the counter configuration information 46. These control signals 49 may configure how a given counter selects the function to be applied to the event status indication 47 and how the increment value is to be selected based on the result of applying the function to the event status indication 47.

The performance monitoring circuitry 40 provides an event counter read interface 50 which allows software to read the event count values for each counter 42. For example, the read interface 50 may be provided by exposing each event count value 43 to the software as system registers which can be read by system register read instructions executed by the processing circuitry 4. Alternatively, the event count values 43 of each event counter 42 may be exposed through a memory-mapped interface so that they can be read by the software executing load instructions specifying memory addresses mapped to the storage locations storing the respective event count values 43. Either way, debugging software can read the current values of each event count value to determine information about what has happened when target software was being processed by the processing circuitry. In use, for example, the debugging software may use breakpoints or watchpoints to trigger an exception when the target software has reached the desired point at which investigation is required (e.g. a desired instruction address reached in program flow, or a desired data address accessed by a memory access instruction), and then when the exception is triggered, an exception handler provided by the debugging software can read out the event count values 43 and analyze the information provided by each event count value 43 to determine what has happened. This can be useful for diagnosing potential performance inefficiencies in the program code, to help identify possible improvements that could be made to the program code being executed to allow it to run more efficiently.

FIG. 3 shows a more detailed example of the counter control logic circuitry for a given event counter 42. The event counter 42 receives its event status indication 47 (denoted as Vb), having been selected by the event selection circuitry 48 based on event type assignment information within the counter configuration information 46. The event counter 42 includes comparison circuitry 52 to compare the event status indication Vb and a threshold value TH and generate a function result value fn[Vb, TH] based on whether the event status indication and the threshold value satisfy a predetermined condition. The threshold value TH and the particular condition tested by the comparison circuitry 52 can both be varied by the user programming the counter configuration information 46. Increment selection circuitry 54 selects between a number of candidate increment values based on at least the function result value fn[Vb, TH]. Three or more candidate increment values (e.g. including 0, 1 and the event status indication Vb itself) may be supported and the counter configuration information 46 may include increment configuration information which specifies which of those candidate increment values are the two candidate increment values from which an increment is selected based on the function result value fn[Vb, TH]. The selected increment value V is used to increment the corresponding event count value 43.

The function used to compute fn[Vb, TH] could be implemented in a number of different ways. In one example, the counter configuration information 46 may specify for a given counter:
the threshold value TH;
function selection information specifying the comparison function to be applied to the event status indication Vb and threshold value (e.g. selecting from a set of alternative functions such as “Vb and TH not equal”, “Vb equals TH”, “Vb is greater than or equal to TH” and “Vb is less than TH”); and
increment configuration information for controlling the selection of the increment.
   In one example, while an increment value of 0 may be selected by default if the function evaluated by comparison circuitry 52 is not satisfied, in the case when the function is satisfied by Vb and TH then the increment value of 1 or Vb itself may be selected, and the increment configuration information may specify which of the alternate increment values 1 and Vb should be selected in the case when the function is satisfied. As noted below, for counters supporting the chained-counter operation, a value dependent on the event status indication tracked by another counter could also be provided as one of the candidate increment values available for selection by increment selection circuitry 54.

In another example (supporting both threshold comparison and edge functions), the function result may depend not only on whether the threshold comparison function is satisfied in the current cycle, but also on whether the threshold comparison function was satisfied in a preceding cycle. Hence, an edge function may be applied to give an edge function result value which indicates whether, between a previous cycle and a current cycle, there has been a change in whether the first event status indication satisfies a predetermined condition. That predetermined condition could be the threshold condition mentioned for the threshold function above. Hence, the edge function result may be a result of computing whether th-fn[Vb_t, TH] and th-fn[Vb_t−1, TH] satisfy an edge condition, where th-fn is the threshold function mentioned above and Vb_t and Vb_t−1 represent the values of the event status indication Vb in the current and preceding cycles respectively. The edge condition may be satisfied if there is a change in value between th-fn[Vb_t, TH] and th-fn[Vb_t−1, TH] and may not be satisfied if th-fn[Vb_t, TH]=th-fn[Vb_t−1, TH]. In some cases, the edge condition may be specific to either a rising edge (e.g. th-fn[Vb_t−1, TH]=false and th-fn[Vb_t, TH]=true) or specific to a falling edge (th-fn[Vb_t−1, TH]=true and th-fn[Vb_t, TH]=false), so may be satisfied only for one of the rising edge and falling edge changes in threshold function result. In other cases, the edge condition may be considered satisfied for both rising and falling edges. Part of the counter configuration information 46 may specify the particular edge condition to be satisfied.

In other examples, rather than applying the edge condition to the previous/current values of the function result fn[Vb, TH], the edge condition could be applied to the event status indication Vb directly, rather than the comparison function result fn[Vb, TH], so that the increment V in the current cycle is selected based on a result of edge-fn[Vb_t−1, Vb_t], independent of any comparison with a threshold value TH. This could be used in implementations which do not support the threshold based comparison at all, or in an implementation which does support the threshold function but provides a configuration option to apply only an edge function without dependence on the threshold comparison. In practice however, if the threshold function is supported, then if it is desired to support applying the edge function to Vb directly, this can be implemented by applying the threshold function fn[Vb, TH] anyway, but setting TH=0 and the threshold comparison function as “Vb and TH not equal”, and then applying the edge condition to the change in status in the function result between one cycle and another cycle. Therefore, it may not be necessary to support a specific control setting which avoids performing the threshold comparison with TH.

Regardless of the particular form of the edge function used, using an edge function can be useful because for some types of events, the event count value can provide more useful diagnostic information if it tracks the number of distinct times there was a change in whether a condition was satisfied by a given event signal, rather than counting each cycle when the condition is satisfied. For example, this could be used to count the number of distinct times a pipeline became stalled.

Hence, it will be appreciated that there can be various ways of calculating a function result as a function of the event status indication Vb, and which particular function computation options are supported may depend on the implementation choice of the system designer.

Often, it can be sufficient to apply the threshold/edge functions described above to an event status indication representing a single event type, to provide useful performance monitoring information.

However, the performance effects encountered when executing software may depend not only on the occurrence of one type of event, but also on the interaction between two or more types of event. For example, it may be desirable to investigate the interaction between outstanding loads pending in a load buffer and cache misses occurring at a given cache, and so it might be useful to count the number of occurrences of a cache miss when the number of outstanding loads also satisfies a particular condition. In this case, incrementing a counter by a threshold which depends on a Boolean AND of function results indicating “cache miss occurred” and “number of outstanding loads is greater than a threshold” might be useful.

Also, in some cases there may be two different kinds of events which can each cause delays in handling software and the total performance cost may correspond the number of cycles in which either one of those two kinds of events occur. If two different event counters separately set to count the number of cycles in which each type of event occurs individually, the sum of those count values may over-estimate the performance cost of those events because cycles where both events occur simultaneously may be counted twice. Therefore, for some use cases it may be more useful for a counter to be incremented based on a Boolean OR of function results indicating a function of the first event type and a function of the second event type respectively.

Therefore, it may be desirable to adapt the counter increment logic so that it can support incrementing a given counter based on the logical combination of statuses of two distinct types of events represented by different event signals 45.

One approach could be to expand each counter 42 so that it can take as inputs event status indications 47 corresponding to two or more of the event signals 45 from the processing circuitry. However, allowing two or more distinct event signals to be selected per event counter 42 would greatly increase the complexity of the event selection circuitry 48 (which, given the large variety of event signals supported in a given processor implementation will tend to require complex multiplexing logic even to select a single event signal per event counter). In practice this is not necessary in order to allow one of the event count values 43 to be incremented by an increment value selected as a logical combination of two or more of the event types.

FIG. 4 shows, for comparison, another approach which could be taken, involving three distinct event counters 42 each having comparison circuitry 52 and increment selection circuitry 54 similar to that shown in FIG. 3. Note that although the event selection circuitry 48 was shown as a single block in FIG. 2, it can also be implemented as a number of distinct multiplexers 48 each associated with the corresponding counter 42 are shown in FIG. 4. In the example of FIG. 4, counters 1 and 2 function in the same way as shown in FIG. 3, each incrementing their respective count values 43(1), 43(2) by an increment value V(1), V(2) computed as a function of the corresponding event status indication Vb1, Vb2 and a corresponding threshold value TH(1), TH(2), TH(3). A third counter is provided with the increment values V(1) and V(2) for counters 1 and 2, and its comparison circuitry 52(3) is given additional circuitry capable of computing a logical function of V(1) and V(2) (e.g. the function could be AND, OR, minimum, maximum etc.). The third counter's increment selection circuitry 54(3) then selects the increment value V(3) for incrementing the third counter's count value 43(3), with increment value V(3) being selected based on the logical function of V(1) and V(2) computed by the third counter's comparison circuitry 52(3). Hence, the event type assigned to the third counter could be regarded as an event corresponding to the logical function (e.g. AND) of the event types (1) and (2) assigned to counters 1 and 2. Note that in this case, the third counter cannot be regarded as incrementing its counter based on the logical combination of event statuses of respective types of events assigned to itself and another counter by the counter configuration information—either counter 3 is regarded as counting the logical combination of event types assigned to two other counters (not itself), or it is regarded as counting its own event type but that event type (the AND result, say) is not logically combined with a further counter's event type. A disadvantage of the approach shown in FIG. 4 is that, to be able to generate an event count value which is incremented based on the logical combination of status indications corresponding to two different event types, this requires three separate counters to be utilised, which in some implementations may be a significant portion of the total number of event counters supported in hardware. Also, this approach requires additional wiring complexity in routing signals from two other counters to the third counter. Also, the V(1) and V(2) values are inputs to the compare circuitry 52(3) meaning the result of this comparator cannot be computed until after the result of the previous two comparators have been computed, which may complicate circuit timings and result in additional logic being needed.

In contrast, in the example shown in FIGS. 5, 6 and 7, a chained-counter operation is implemented where a given event counter 42 increments its event count value 43 based on the logical combination of the event status indications corresponding to the event type assigned to the given event counter itself and one other event counter. This can be more efficient because it reduces the amount of inter-counter wiring and avoids the necessity of occupying three separate counters to track the combination of first and second events-if a user determines that it is not necessary to separately count each of the first and second events individually, then only two counters are occupied (one to count the second event, and another to count the logical combination of the first and second events) and the third counter shown in FIG. 4 can be freed for use in monitoring an unrelated event separate from the first/second events. Hence, utilisation of counters can be improved as well as reducing the hardware complexity.

For example, as shown in FIG. 5, a given event counter 42(N) is assigned as the counter which is to increment its event count signal 43(N) based on the logical combination of event types assigned to be monitored by the given event counter 42(N) itself and a further event counter 42 (N−1). The incrementing of the event count value 43(N−1) for the further event counter is performed based on the event status indication Vb(N−1) selected by event selection circuitry 48 for that counter based on the counter configuration information 46, in the same way as discussed for FIG. 3, for example based on applying a threshold and/or edge function using comparison circuitry 52(N−1). However, a value depending on event status indication Vb(N−1) is provided by further event counter 42(N−1) to the given event counter 42(N) for use in the chained-counter operation. In this example, the value provided to the given event counter 42(N) is the increment value V(N−1) selected by the increment selection circuitry 54(N−1) of the further event counter 42(N−1).

The comparison circuitry 52(N) of the given event counter 42(N) generates the function result fn(N) based on its event status indication Vb(N) and the threshold value TH(N), in a similar way to described above for FIG. 3. Both the function fn(N) applied by comparison circuitry 52(N) and the threshold value TH(N) for counter 42(N) may be set by the counter configuration information 46, independently of selection of the corresponding function fn(N−1) and threshold value TH(N−1) used for counter 42(N−1). Hence, the two counters may apply different functions and/or use different threshold values. In the example of FIG. 5, the function result fn(N) [Vb(N), TH(N)] generated by comparison circuitry 52(N) depends on the first event status signal Vb(N) corresponding to the event type assigned to be monitored by counter 42(N), but is independent of the second event status signal Vb(N−1) corresponding to the event type assigned to be monitored by counter 42(N−1). In this example, the function applied is the threshold function discussed above and so the function result is fn(N) [Vb(N), TH(N)], but it will be appreciated that edge functions or other functions could also be applied to the first event status indication Vb(N).

The value V(N−1) from counter 42(N−1) is provided to the increment selection circuitry 54(N) as an additional candidate increment value available for selection as V(N), the value by which event count value 43(N) for counter 42(N) is to be incremented. Hence, V(N) can be selected from among the set {0, 1, Vb(N), V(N−1)} based on the increment configuration information defined by counter configuration information 46 for counter 42(N), and the function result fn(N) computed by comparison circuitry 52(N) for counter 42(N).

For example, one approach can be to provide encodings in the counter configuration information to allow the following increment control settings to be implemented for a particular event counter 42(i) supporting the chained-counter operation:

| Setting | If fn(i) result is true, V(i) is: | If fn(i) result is false, V(i) is: |
|---|---|---|
| A | 1 | 0 |
| B | Vb(i) | 0 |
| C | 0 | V(i − 1) |
| D | 1 | V(i − 1) |
| E | Vb(i) | V(i − 1) |

where Vb(i) is the event status indication 47 selected by event selection circuitry 48 for counter 42(i) and V(i−1) is the increment value selected by increment selection circuitry 54(N−1) associated with counter 42(i−1) based on Vb(i−1), the event status indication 47 selected for counter 42(i−1).

It will be appreciated that it is not essential for all of the settings shown above to be supported in a given implementation. Some implementations may also support additional settings (e.g. settings which flip the selection so that the increment shown as being selected for the “true” function result is instead selected on a “false” function result, and vice versa). At least counter 42(N) in the example of FIG. 5 implements at least one of settings C, D and E. Counter 42(N−1) in FIG. 5 does not need to implement any of settings C, D or E, but could do if desired to allow chains of three or more counters to be implemented.

By providing counter 42(N) with at least one setting (e.g. C, D or E) where V(N−1) can be selected as the increment to be applied to the event current value 43(N) for counter 42(N), this can support logical combinations between the first/second event types such as Boolean AND or combinations. Hence, settings C, D, E for counter 42(N) correspond to settings of the counter configuration information which cause counter 42(N) to implement the chained-counter operation, while settings A and B correspond to non-chained-counter operations as in that case the increment selected by counter 42(N) will be independent of Vb(N−1).

For example, if the first event status indication Vb(N) and the second event status indication Vb(N−1) are both positive multi-bit integers, the thresholding functions of counters 42(N) and 42(N−1) can be used to simulate AND OR combinations of the first/second event types, as follows:

### AND (Test if Both Vb(N) and Vb(N−1) are Non-Zero)

### Setting for Counter 42(N−1):

threshold function: Vb(N−1)!=0 or Vb(N−1)>=1;
increment control setting—setting A.
   (this is the identity function, with a reduction of the output to either 0 or 1).

### Setting for Counter 42(N):

threshold function: Vb(N)==0 or Vb(N)<1;
increment control setting—setting C or E.
   This causes V(N) to take values as follows:

| | | | | | Input | |
|---|---|---|---|---|---|---|
| | | V(N − | | | selected | |
| Vb(N − 1) | fn(N − 1) | 1) | Vb(N) | fn(N) | by 54(N) | V(N) |
| 0 | false | 0 | 0 | true | 0 or Vb(N) | 0 |
| 0 | false | 0 | non-zero | false | V(N − 1) | 0 |
| non-zero | true | 1 | 0 | true | 0 or Vb(N) | 0 |
| non-zero | true | 1 | non-zero | false | V(N − 1) | 1 |

Hence, it can be seen that V(N) corresponds to the logical AND of Vb(N−1) and Vb(N).

### OR (Test if Either Vb(N) or Vb(N−1) is Non-Zero)

### Setting for Counter 42(N−1):

threshold function: Vb(N−1)!=0 or Vb(N−1)>=1;
increment control setting-setting A.

### Setting for Counter 42(N):

threshold function: Vb(N)!=0 or Vb(N)>=1;
increment control setting-setting E (if the result for Vb(N) is desired to be equal to Vb(N) if the OR result is satisfied) or setting D (if Vb(N) is to be a 0 or 1 result).
   Assuming setting D for counter 42(N), this causes V(N) to take values as follows:

| | | | | | Input | |
|---|---|---|---|---|---|---|
| | | | | | selected | |
| Vb(N − 1) | fn(N − 1) | V(N − 1) | Vb(N) | fn(N) | by 54(N) | V(N) |
| 0 | false | 0 | 0 | false | V(N − 1) | 0 |
| 0 | false | 0 | non-zero | true | 1 | 1 |
| non-zero | true | 1 | 0 | false | V(N − 1) | 1 |
| non-zero | true | 1 | non-zero | true | 1 | 1 |

Hence, it can be seen that V(N) corresponds to the logical OR of Vb(N−1) and Vb(N).
Other functions, such as NAND (inverse of the AND result), AND NOT (AND of the inverse of one input value and the inverse of the other input value). NOR (inverse of the OR result), and OR NOT (OR of the inverse of one input value and the inverse of the other input value), can be constructed in a similar way.

Hence, by a relatively simple modification of the counter logic (expanding increment selection multiplexer to take an additional input corresponding to V(N−1) from a further counter), the logical combinations between two event types can be used to generate a counter increment with much less complex hardware circuitry than in FIG. 4 and with only two counters required to be occupied.

This can be useful, for example, to count each occurrence of a second event when a first event is above (or below) a threshold value, for example:
the first event assigned to counter 42(N−1) could be the occurrence of an interesting event, such as a cache miss;
the second event assigned to counter 42(N) could be the number of outstanding loads in each cycle.
   Hence, the chained-counter operation can be used to count occurrences of cache misses in a cycle when the number of outstanding loads is greater than or equal to a threshold value TH(N) by configuring:
counter 42(N−1) to not implement any threshold test, e.g. by computing fn(N−1) directly from Vb(N−1), or by applying the threshold function but using a threshold value TH(N−1) of 0 and a comparison function of Vb(N−1)>=TH(N−1)).
counter 42(N) to use a threshold test of Vb(N)>=TH(N) and control setting C for the increment control logic.
   This is just one example and many other instances of investigating co-occurrence of particular pairs of events can be implemented. It is noted that in FIG. 5, although the selected increment V(N) may depend on the value V(N−1) being computed, V(N−1) can come into the logic for computing V(N) much later than in FIG. 4, which is better timing-wise as it means the function comparison for 52(N) does not need to wait for V(N−1) to be computed. Timing-wise a multiplexer 54 is much shallower logic than a comparator 52, particularly if that comparator is capable of magnitude comparisons (which may use an adder circuit to subtract one of the comparison inputs from the other—the adder circuit may require deeper circuit logic than a multiplexer). Therefore, there can be a performance advantage to avoiding V(N−1) being an input to comparison circuitry 52(N).

Also, while FIG. 5 shows an example of chaining together two counters to provide logical combinations of first and second events, if the counter 42(N−1) itself also implements the chained-counter operation and so can receive as an input the value V(N−2) obtained by another counter based on its event status indication Vb(N−2), this can allow AND or based logical combinations of three or more distinct event types to be combined and used to select the increment for counter 42(N). Hence, while the chained-count operations are shown for two counters, it is also possible for the increment value V(N−1) selected by counter 42(N−1) itself to be dependent on the event status indication Vb(N−2) for another counter 42(N−2) as well as the event status indications Vb(N) and Vb(N−1) shown in FIG. 5.

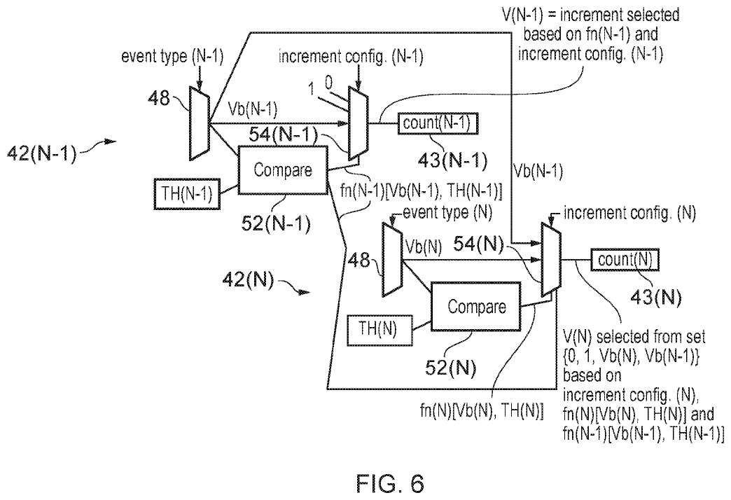

FIG. 6 illustrates an alternative approach to implementing the chained-counter operation (e.g. for implementing the same behaviour for counting co-occurrence of events such as outstanding loads and cache misses as described above for FIG. 5). In this example, the calculation of comparison function results fn(N−1) and fn(N) for counters 42(N−1) and 42(N) are the same as in FIG. 5. However, instead of providing the increment value V(N−1) selected by counter 42(N−1) to the counter 42(N) as an additional input to the increment selection multiplexer 54(N), the second event status indication Vb(N−1) selected by event selection circuitry 48 for event counter 42(N−1) is provided as a candidate increment value available for selection by the increment selection multiplexer 54(N) in event counter 42(N). Also, the function result fn(N−1) from comparison circuitry 52(N−1) in counter 42(N) is provided as an additional control input to the increment selection circuitry 54(N) in event counter 42(N), so that the increment value V(N) for incrementing count value 43(N) is selected from the set {0, 1, Vb(N), Vb(N−1)} based on the increment configuration information which defines the increment control setting for counter 42(N) (in some examples, the increment control setting for counter 42(N−1) could also be considered), the function result fn(N) computed by comparison circuitry 52(N) based on Vb(N) and the function result fn(N−1) computed by comparison circuitry 52(N−1) based on Vb(N−1). This approach can help improve circuit timings in some implementations, as it eliminates one multiplexer from the path between Vb(N−1) and increment selection multiplexer 54(N) for event counter 42(N). Hence, in this case, the values dependent on Vb(N−1) which are considered by counter 42(N) may be Vb(N−1) itself, which is used as a candidate increment value for selection by increment selector 54(N), and the function result fn(N−1), which is used as a control input for the increment selector 54(N).

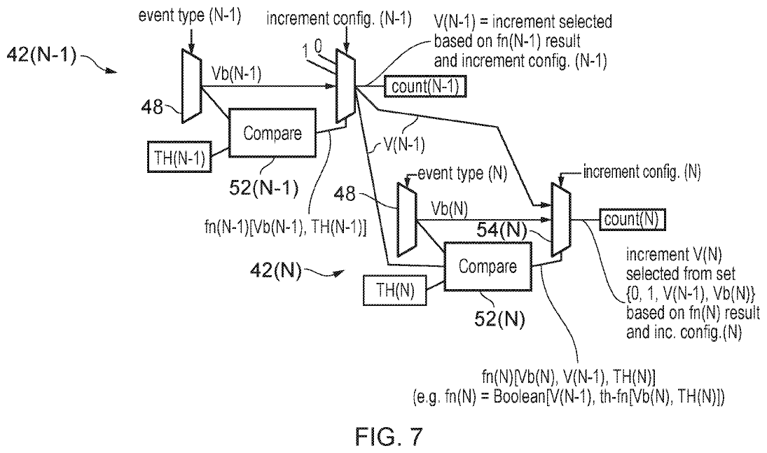

FIG. 7 illustrates another alternative. In this case, similar to FIG. 5 the increment value V(N−1) selected by counter 42(N−1) based on Vb(N−1) is provided as a candidate increment available for selection by the increment selector 54(N) in counter 42(N). However, in FIG. 7, the function result fn(N) used by increment selector 54(N) to select between the candidate increments {0, 1, V(N−1), Vb(N)} depends not only on Vb(N) but also on V(N−1). For example, the comparator 52(N) could take three inputs Vb(N), V(N−1), TH(N) and configuration information may specify which of the three inputs should be compared according to the comparison function. The result of that function may then be used to control which increment value is selected as V(N) by increment selector 54(N). This approach can allow the first/second event status indications for counters 42(N) and 42(N−1) to be compared directly, so can be more flexible in supporting additional forms of logical combination of the first/second event status indications (e.g. maximum and minimum) which are not supported in implementations where the second event status for counter 42(N−1) influences the increment selection but not the event comparison function for counter 42(N) as in FIGS. 5 and 6.

Note that, in comparison to FIG. 4, each of FIGS. 5, 6 and 7 differ in that counter 42(N) counts the logical combination of the event counter 42(N) is programmed to count and the event another counter 42(N−1) is programmed to count (rather than counting the logical combination of the events assigned to two other counters, not itself). Also, in the approach shown in FIGS. 5 and 6 there is no need to compare the event status indications Vb(N) and Vb(N−1) directly, as instead each is compared against a fixed threshold TH(N) or TH(N−1) and then this is used to select which of the increment values (including a value derived from event counter 42(N−1) is used to increment count value 43(N) for event counter 42(N).

FIGS. 5 to 7 show an example where, for a given counter supporting the chained-counter operation, the selection of which the counter is the further event counter is fixed in hardware and is limited to be the counter with the next lowest counter number N−1 after the counter number N of the given counter itself. However, other examples may be more flexible in varying which the counter is the further event counter, based on the counter configuration information 46.

It is not essential for every event counter 42 to support the chained-counter operation as shown in FIGS. 5 to 7. In some cases, the ability to support the chain-counter operation may be limited to a subset of the counters 42, and other counters may behave as shown in FIG. 3 without considering any information relating to the status of an event type assigned to be monitored by another event counter.

Also, it will be appreciated that a counter that does support the chained-counter operation can also be configured to perform a non-chained counter operation (e.g. by selecting one of the control settings A and B described above which does not select the increment value V(N) based on a value dependent on the second event status indication Vb(N−1) for another counter).

FIG. 8 is a flow diagram showing a method of performance monitoring using event counters. At step 100 the event counters are configured by the user setting the counter configuration information 46. The counter configuration information includes event assignment information indicating the type of event assigned to be monitored by a given counter, and may include function configuration information for configuring the function to be applied by comparison circuitry 52 for a given counter (e.g. specifying whether the threshold/edge function is to be applied, specifying the specific comparison condition to be applied in the threshold/edge function, and/or specifying the threshold value TH for a threshold function) and increment configuration information (e.g. information selecting one of settings A-E as discussed above). The counter configuration information defines the rules for selecting between candidate increment values depending on the result of the function computed by comparison circuitry 52 for a given counter. This information may be defined separately per event counter 42.

At step 102, software is executed on the processing circuitry 4. Meanwhile, the event counters 42 maintain the respective event count values 43 based on monitoring of their configured event types. The event counters 42 operate in hardware, in the background of the software processing, so do not require specific software instructions to be executed in order to update their respective event count values 43.

At step 104, the event count values 43 from the event counters 42 are read out via the read out interface 50. For example, this may occur when the software executed at step 102 encounters a breakpoint (when program flow reaches a particular program counter address or a breakpoint instruction is executed) or watchpoint (when a data access is made to a particular data address), triggering an exception which causes debug software to be executed to read out the event counters and then analyse the count values.

FIG. 9 is a flow diagram showing a method of performing performance monitoring in an implementation supporting a chained-counter operation. At step 110, control circuitry 44 determines whether the counter configuration information 46 has been set to specify that a given event counter 42(N) should perform a chained-counter operation. If not, then at step 112, the given event counter 42(N) maintains its given event count value 43(N) based on a non-chained-counter operation, e.g. using the approach discussed with respect to FIG. 3.

If a given event counter 42(N) has been configured to perform a chained-counter operation, then at step 114 counter 42(N) increments the given event count value by an increment value determined based on a logical combination of a first event status indication Vb(N) and a second event status indication Vb(N−1). The first event status indication Vb(N) indicates the status of a first event type assigned by the counter configuration information 46 to be monitored by the given event counter 42(N) itself, while the second event status indication Vb(N−1) indicates the status of a second event type assigned by the counter configuration information 46 to be monitored by a further event counter 42(N−1).

FIG. 10 is a flow diagram illustrating a chained-counter operation in more detail. At step 120, the given event counter 42(N) that has been configured to perform the chained-counter operation determines a first event status function result value fn(N) as a function of at least the first event status indication Vb(N). The first event status function result value fn(N) could also depend on other information, such as part of the counter configuration information 46 and/or information derived from the further counter 42(N−1), such as the increment value V(N−1) selected by counter 42(N−1) in the example of FIG. 7.

At step 122, the given event counter 42(N) selects an increment value V(N) from among a plurality of candidate increment values depending (at least) on the first event status function result value fn(N). The candidate increment values include a value depending on the second event status indication (e.g. the increment V(N−1) selected by further event counter 42(N−1), or the second event status indication Vb(N−1)) and at least one further increment value (e.g. 0, 1 and/or the first event status indication Vb(N)). The increment selection at the given event counter 42(N) may also depend on increment configuration information which may specify which setting is to be used for selecting between the candidate increment values depending on the first event status function result value fn(N). As shown in FIG. 6, the increment selection could also depend on information from the further event counter 42(N−1), such as the function result fn(N−1) computed by counter 42(N−1) based on the second event status indication Vb(N−1).

At step 124, the given event counter 42(N) increments the given event count value 43(N) based on the increment value V(N) selected at step 122.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Also, FIG. 11 illustrates a simulator implementation that may be used. Whilst the earlier described embodiments implement the present invention in terms of apparatus and methods for operating specific hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 230, optionally running a host operating system 220, supporting the simulator program 210. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 230), some simulated embodiments may make use of the host hardware, where suitable.

The simulator program 210 may be stored on a computer-readable storage medium (which may be a non-transitory medium), and provides a program interface (instruction execution environment) to the target program code 200 (which may include applications, operating systems and a hypervisor) which is the same as the interface of the hardware architecture being modelled by the simulator program 210. Thus, the program instructions of the target code 200, including instructions for setting the counter configuration information 46 and for reading out event count values 43, may be executed from within the instruction execution environment using the simulator program 210, so that a host computer 230 which does not actually have the hardware features of the apparatus 2 discussed above can emulate these features. The functions of the performance monitoring circuitry 40 can be emulated by corresponding program logic. By providing a simulation of the apparatus shown in FIG. 1 in a software form, this can allow debugging software for interacting with the performance monitoring circuitry 40 to be developed before the hardware is actually available.

Hence, the simulator program 210 may have processing program logic 212 which simulates the state of the processing circuitry 4 described above. For example the processing program logic 212 may control transitions of execution state (e.g. exception level, operating mode) in response to events occurring during simulated execution of the target code 200. Instruction decoding program logic 214 decodes instructions of the target code 200 and maps these to corresponding sets of instructions in the native instruction set of the host apparatus 230. The register emulating program logic 213 maps register accesses requested by the target code to accesses to corresponding register-emulating data structures 233 maintained by the host hardware of the host apparatus 230, such as by accessing data in registers or memory 232 of the host apparatus 230. Memory management program logic 215 implements address translation, page table walks and access control checking in a corresponding way to the MMU 28 described in the hardware-implemented embodiment above, but also has the additional function of mapping simulated physical addresses obtained by the simulated MMU 28 to host virtual addresses used to access host memory 232. These host virtual addresses may themselves be translated into host physical addresses using the standard address translation mechanisms supported by the host (the translation of host virtual addresses to host physical addresses being outside the scope of what is controlled by the simulator program 210). Hence, the simulated physical address space accessed by the target code 200 can be mapped to a region 234 of host memory 232 representing the simulated target memory 30, 32, 34 of the target processing apparatus 2 being simulated by the simulation program 210.

The simulator program 210 has performance monitoring program logic 216 which simulates the behaviour of the performance monitoring circuitry 40, and includes event counter program logic 217 which increments event count values 235 maintained in host memory 232 based on the event increment functions described above for the event counters 42 in the hardware embodiment. Also, the performance monitoring program logic 216 includes control program logic 218 which accesses the counter configuration information 236 specified in host memory 232 and depending on the counter configuration information 236 adapts how the event counting program logic 217 increments the event counter values 235. The performance monitoring program logic 216 may support chained-counter operations in a similar way to those described above for hardware event counters.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. Performance monitoring circuitry for monitoring performance of software executing on processing circuitry; comprising:
a plurality of event counters each to maintain a respective event count value based on monitoring of events during processing of the software by the processing circuitry; and
control circuitry to configure the event counters based on counter configuration information, the counter configuration information comprising event type assignment information indicative of which types of event are assigned to be monitored by the event counters; wherein:
for at least a subset of the event counters, a given event counter in the subset is configured to support a chained-counter operation for at least one setting of the counter configuration information, and the given event counter is configured to maintain a given event count value;
the chained-counter operation comprising incrementing the given event count value by an increment value determined based on a logical combination of a first event status indication indicative of status of a first event type assigned by the counter configuration information to be monitored by the given event counter and a second event status indication indicative of status of a second event type assigned by the counter configuration information to be monitored by a further event counter.

2. The performance monitoring circuitry according to claim 1, in which the counter configuration information comprises information for specifying which logical combination is to be used for combining the first event status indication and the second event status indication.

3. The performance monitoring circuitry according to claim 1, in which the chained-counter operation comprises:
determining a first event function result value for the given event counter as a function of at least the first event status indication, and
selecting one of a plurality of candidate increment values as the increment value for incrementing the given event count value based on selection control information depending on at least the first event function result value; and
at least one of the first event function result value, the selection control information and one or more of the candidate increment values depends on a value dependent on the second event status indication.

4. The performance monitoring circuitry according to claim 3, in which at least one of the selection control information and said one or more of the candidate increment values depends on the value dependent on the second event status indication.

5. The performance monitoring circuitry according to claim 3, in which the plurality of candidate increment values include the value dependent on the second event status indication and at least one further increment value.

6. The performance monitoring circuitry according to claim 5, in which the at least one further increment value comprises at least one of:
0;
1; and
the first event status indication.

7. The performance monitoring circuitry according to claim 3, in which the selection control information depends on the value dependent on the second event status indication.

8. The performance monitoring circuitry according to claim 3, in which the first event function result value depends on the value dependent on the second event status indication.

9. The performance monitoring circuitry according to claim 3, in which the selection of the increment value also depends on the counter configuration information for the given event counter.

10. The performance monitoring circuitry according to claim 3, in which the value dependent on the second event status indication comprises one of:
the second event status indication;
a second event function result value determined for the further event counter as a function of at least the second event status indication; and
a second increment value selected for incrementing the further event counter based on at least the second event function result value.

11. The performance monitoring circuitry according to claim 3, in which, for at least one setting of the counter configuration information, the first event function result value comprises a threshold function result value indicative of whether the first event status indication and a threshold value satisfy a threshold condition.

12. The performance monitoring circuitry according to claim 11, in which the threshold value is specified by the counter configuration information.

13. The performance monitoring circuitry according to claim 3, in which, for at least one setting of the counter configuration information, the first event function result value comprises an edge function result value indicative of whether, between a previous cycle and a current cycle, there has been a change in whether the first event status indication satisfies a predetermined condition.

14. The performance monitoring circuitry according to claim 1, in which:
for the chained-counter operation performed by the given event counter, selection of which other event counter is the further event counter is fixed, independent of the counter configuration information.

15. The performance monitoring circuitry according to claim 1, in which the counter configuration information variably specifies which other event counter is the further event counter for the chained-counter operation performed by the given event counter.

16. An apparatus comprising:
the performance monitoring circuitry according to claim 1; and
the processing circuitry.

17. A computer-readable medium to store computer-readable code for fabrication of the performance monitoring circuitry according to claim 1.

18. A method for monitoring performance of software executing on processing circuitry; the method comprising:
configuring a plurality of event counters based on counter configuration information, the counter configuration information comprising event type assignment information indicative of which types of event are assigned to be monitored by the event counters;
using the plurality of event counters, maintaining respective event count values based on monitoring of events during processing of the software by the processing circuitry; and
for a given event counter within at least a subset of the event counters, performing a chained-counter operation for at least one setting of the counter configuration information, the given event counter maintaining a given event count value;
the chained-counter operation comprising incrementing the given event count value by an increment value determined based on a logical combination of a first event status indication indicative of status of a first event type assigned by the counter configuration information to be monitored by the given event counter and a second event status indication indicative of status of
a second event type assigned by the counter configuration information to be monitored by a further event counter.

19. A computer program comprising instructions which, when executed by a host data processing apparatus, control the host data processing apparatus to provide an instruction execution environment for executing target program code, the computer program comprising:
event counting program logic to maintain a plurality of event count values based on monitoring of events during simulated processing of the target program code by target processing circuitry; and
control program logic to configure the event counting program logic based on counter configuration information, the counter configuration information comprising event type assignment information indicative of which types of event are assigned to be monitored using the plurality of event count values by the event counting program logic; wherein:
for at least a subset of the event count values, for at least one setting of the counter configuration information the event counting program logic is configured to support a chained-counter operation for maintaining a given event count value in the subset;
the chained-counter operation comprising incrementing the given event count value by an increment value determined based on a logical combination of a first event status indication indicative of status of a first event type assigned by the counter configuration information to be monitored using the given event count value and a second event status indication indicative of status of a second event type assigned by the counter configuration information to be monitored by a further event counter.

20. A computer-readable storage medium storing the computer program of claim 19.
